(19) United States
(12) Patent Application Publication
(10) Pub. No.: US 2016/0036797 A1
(43) Pub. Date: Feb. 4, 2016

(54) Information Processing Device and Information Processing System

(71) Applicant: Seiko Epson Corporation, Tokyo (JP)

(72) Inventors: Takahiro Mano, Shiojiri-shi (JP); Yoshinori Matsumura, Matsumoto-shi (JP)

(21) Appl. No.: 14/802,365

(22) Filed: Jul. 17, 2015

(30) Foreign Application Priority Data
Jul. 31, 2014 (JP) 2014-155932

(51) Int. Cl. H04L 29/06; H04L 29/08

(52) U.S. Cl. CPC H04L 63/08; H04L 67/10

(57) ABSTRACT

An information processing device includes a communication unit that makes communication with a maintenance service provision unit providing maintenance service and the communication unit transmits specification information specifying the information processing device to the maintenance service provision unit.

### 1. TECHNICAL FIELD

The present invention relates to an information processing device and an information processing system.

### 2. RELATED ART

An existing image processing device that requests connection of communication with a support connection destination by pressing a help key by a user has been known (for example, see Japanese Unexamined Patent Application Publication No. 2010-74522). Further, support service with which a predetermined number is issued when a terminal accesses a server and a user and the predetermined number are related to each other has been known (for example, see Japanese Unexamined Patent Application Publication No. 2011-171986).

In the above-mentioned support service, there has been however a problem that when the user receives service provision from the support service side, the user cannot easily receive service with reduced user's burden.

### SUMMARY

An advantage of some aspects of the invention has been made in order to solve at least a part of the above-mentioned problem and can be realized as the following modes or Application Examples.

### Application Example 1

An information processing device according to an Application Example includes a communication unit that makes communication with a maintenance service provision unit providing maintenance service, wherein the communication unit transmits specification information specifying the information processing device to the maintenance service provision unit.

With this configuration, the specification information is transmitted to the maintenance service provision unit from the communication unit. The specification information that is transmitted contains information specifying the information processing device which is to receive the maintenance service. Therefore, user's burden is reduced and the maintenance service provision unit easily specifies (authenticates) the information processing device which is to receive provision of the maintenance service, so that the user can receive the provision of the service easily.

### Application Example 2

In the information processing device according to the above-mentioned Application Example, the specification information may contain at least individual information specifying the information processing device or positional information specifying a position of the information processing device.

With this configuration, the specification information contains the individual information such as a serial number and device information or the positional information such as an IP address, for example. Therefore, the information processing device can be specified easily.

### Application Example 3

In the information processing device according to the above-mentioned Application Example, a recognizing unit which recognizes start of the maintenance service may be further provided, and when the recognizing unit has recognized a predetermined condition for starting the maintenance service, the specification information may be transmitted to the maintenance service provision unit.

With this configuration, the specification information is transmitted after the predetermined condition of the maintenance service is recognized. Therefore, safe information communication can be made without mistaking another information processing device for the target information processing device.

### Application Example 4

In the information processing device according to the above-mentioned Application Example, the communication unit may receive authentication information generated by the maintenance service provision unit based on the specification information through a communication circuit.

With this configuration, the authentication information can be acquired easily.

### Application Example 5

In the information processing device according to the above-mentioned Application Example, the authentication information may be generated by the specification information and information included in the maintenance service provision unit.

With this configuration, the information processing device which is to receive the maintenance service can be specified reliably.

### Application Example 6

In the information processing device according to the above-mentioned Application Example, a display unit which displays the received authentication information may be provided.

With this configuration, the user can check the authentication information displayed on the display unit.

### Application Example 7

In the information processing device according to the above-mentioned Application Example, communication may be encrypted based on the authentication information.

With this configuration, the communication is encrypted so as to prevent information from being read by other people and illegal operations from being performed.

### Application Example 8

In the information processing device according to the above-mentioned Application Example, communication with anything other than the maintenance service provision unit may be capable of being shut out.

With this configuration, one-to-one correspondence between the information processing device and the maintenance service provision unit is established. Therefore, safe communication can be performed while accesses from other people are rejected.

### Application Example 9

In the information processing device according to the above-mentioned Application Example, after communication with anything other than the maintenance service provision unit is shut out, information of the maintenance service may be received from the maintenance service provision unit.

With this configuration, the information processing device receives the information of the maintenance service from the maintenance service provision unit in a state where the one-to-one correspondence between the information processing device and the maintenance service provision unit is established. Therefore, communication environment is established safely.

### Application Example 10

An information processing system according to this Application Example transmits specification information specifying an information processing device to a maintenance service provision unit providing maintenance service.

With this configuration, the specification information is transmitted to the maintenance service provision unit from the communication unit. The specification information that is transmitted contains information specifying the information processing device which is to receive the maintenance service. Therefore, user's burden is reduced and the maintenance service provision unit can easily specify (authenticate) the information processing device which is to receive provision of the maintenance service.

### BRIEF DESCRIPTION OF THE DRAWINGS

The invention will be described with reference to the accompanying drawings, wherein like numbers reference like elements.

FIG. 1 is a configuration diagram illustrating the configuration of an information processing system.

FIGS. 2A and 2B are configuration diagrams illustrating the configuration of an information processing device.

FIG. 3 is a block diagram illustrating the configuration of a maintenance service provision unit.

FIG. 4 is a flowchart illustrating an information processing method in the information processing system.

FIG. 5 is a configuration diagram illustrating the configuration of an information processing device according to a modification.

### DESCRIPTION OF EXEMPLARY EMBODIMENTS

Hereinafter, an embodiment of the present invention will be described with reference to the drawings. In the following respective drawings, individual members and the like are illustrated in scales different from actual scales in order to make the individual members and the like have recognizable sizes.

First, the configuration of an information processing system will be described. The information processing system transmits specification information specifying an information processing device to a maintenance service provision unit which provides maintenance service. Details thereof will be described hereinafter.

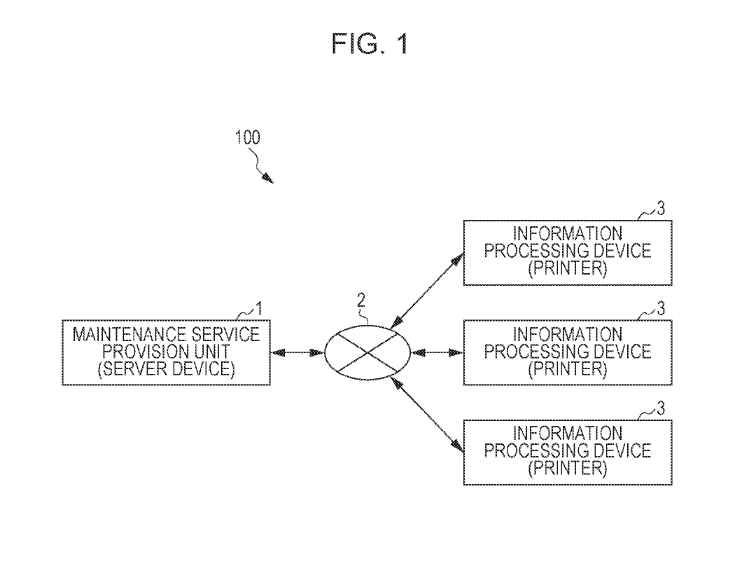

FIG. 1 is a configuration diagram illustrating the configuration of the information processing system. As illustrated in FIG. 1, an information processing system 100 includes a maintenance service provision unit 1, information processing devices 3, and a communication circuit 2 connecting the maintenance service provision unit 1 and the information processing devices 3.

In the information processing system 100 in the embodiment, the plurality of information processing devices are connected to the communication circuit 2, as an example. The information processing system 100 is established by connecting the maintenance service provision unit 1 and at least one information processing device 3 through the communication circuit 2. Accordingly, the number of information processing devices 3 is not limited to that as illustrated in FIG. 1 and is arbitrary. Further, the configuration of the communication circuit 2 is not particularly limited and the communication circuit 2 may be wired or wireless as long as it can make bidirectional communication between the maintenance service provision unit 1 and the information processing devices 3.

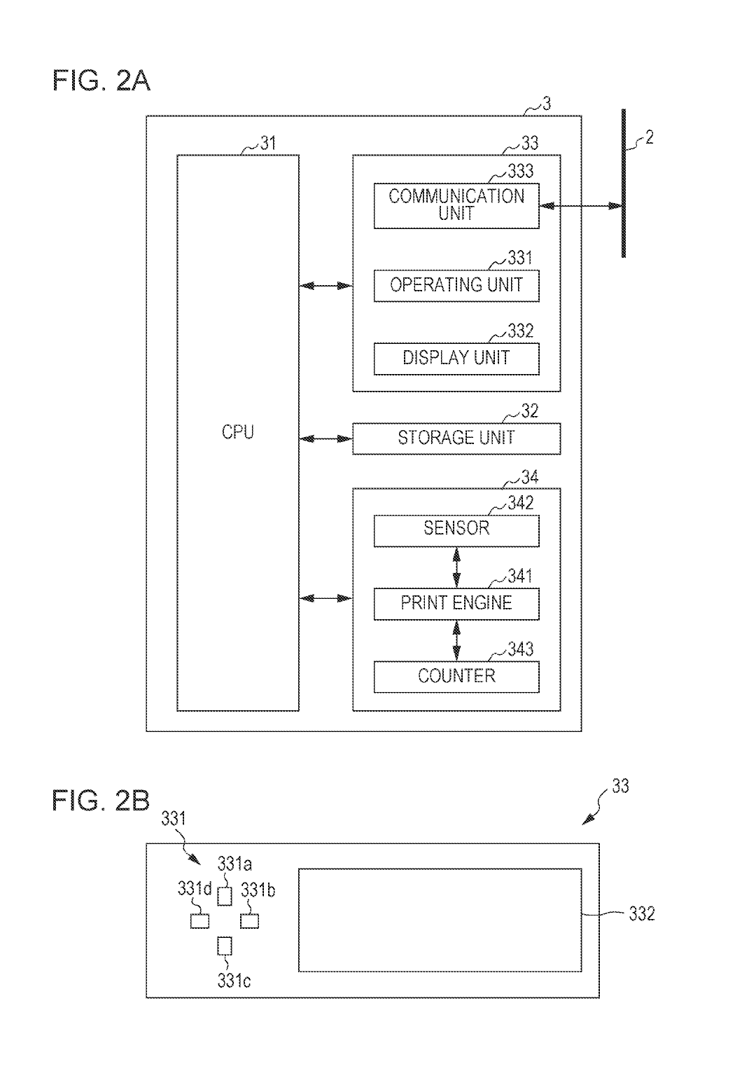

Next, the configuration of the information processing device will be described. The information processing device includes a communication unit that makes communication with the maintenance service provision unit providing maintenance service and the communication unit transmits specification information specifying the information processing device to the maintenance service provision unit. In the embodiment, a printer (hereinafter, referred to as printer 3) as the information processing device 3 is described as an example. FIGS. 2A and 2B illustrate the configuration of the information processing device (printer), FIG. 2A is a block diagram illustrating the configuration of the information processing device (printer), and FIG. 2B is a schematic diagram illustrating a partial configuration of an interface unit.

The printer 3 is an image forming device that forms an image on a recording medium such as paper, a fabric, a resin sheet, and a metal sheet using a recording material such as ink and toner, for example. There are recording systems of various types therefor and an arbitrary recording system can be applied. For example, an ink jet system can be employed. As illustrated in FIG. 2A, the printer 3 includes a central processing unit (CPU) 31, a storage unit 32, an interface unit 33, and a print unit 34. The CPU 31 controls individual parts by executing previously stored firmware. The storage unit 32 temporarily stores therein image data to be printed. The interface unit 33 performs information exchange with external devices. The print unit 34 executes a print operation in accordance with a control direction from the CPU 31.

As illustrated in FIG. 2B, the interface unit 33 includes an operating unit 331 and a display unit 332 as the configurations serving as the user interface. The operating unit 331 has keys (buttons) for input operations from a user. The display unit 332 displays various types of information. The operating unit 331 and the display unit 332 may be integrally configured as a touch panel, for example. The operating unit 331 in the embodiment is configured by four keys 331a, 331b, 331c, and 331d. When the display unit 332 receives information transmitted from the maintenance service provision unit 1, it can display the received information.

The interface unit 33 further includes a communication unit 333. The communication unit 333 has a network connection function for connecting the printer 3 to the communication circuit 2. Further, the communication unit 333 is configured so as to transmit specification information specifying the printer 3 to the maintenance service provision unit 1 through the communication circuit 2. That is to say, the printer 3 as a target can be specified from the plurality of printers 3 connected to the maintenance service provision unit 1 through the communication circuit 2. The specification information is information containing at least individual information specifying the printer 3 or positional information specifying a position of the printer 3. For example, an IP address, a serial number (manufacturing number), and the like that are unique to the printer 3 are applied.

The print unit 34 includes a print engine 341 as a main section of the print operation. The print engine 341 forms an image corresponding to the image data on the recording medium in accordance with a control direction from the CPU 31. Further, sensors 342 and counters 343 are provided on the print unit 34. The sensors 342 detect physical amounts of various types, which are related to an operation state of the print engine 341. The counters 343 count numerical values of various types, which change with the operation of the print engine 341.

When the print engine 341 is an ink jet system, for example, the physical amounts indicating the operation state thereof include a voltage that is applied to electric parts of the print engine 341, a temperature and humidity in the device, positions of a print head and the recording medium, and the like. As the sensors 342 for detecting them, sensors of various types such as a voltage sensor, a temperature and humidity sensor, a positional sensor and an acceleration sensor are provided. Further, for example, the numerical values, which change with the operation of the print engine 341, include total operation time of the device, the number of print sheets, an ink usage amount (or residual amount), the accumulated rotation amounts of rotating mechanical parts, and the like. The counters 343 of various types for counting them are provided.

Pieces of data that are output from the sensors 342 and the counters 343 are stored in the storage unit 32 as pieces of operation information indexing the operation condition of the printer 3 and are used for the operation control of the print engine 341 by the CPU 31. Further, the pieces of operation information are transmitted to the maintenance service provision unit 1, so that the maintenance service provision unit 1 can grasp the operation condition of the printer 3.

The CPU 31 has a function as a recognizing unit that recognizes the start of the maintenance service from the maintenance service provision unit 1. The CPU 31 is configured so as to cause the communication unit 333 to transmit the specification information to the maintenance service provision unit 1 when it has recognized a predetermined condition for starting the maintenance service.

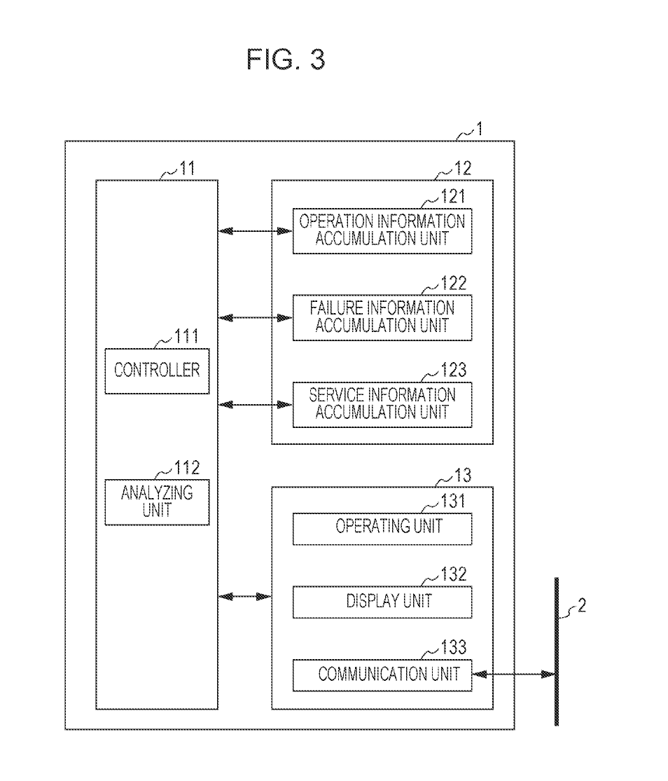

Next, the configuration of the maintenance service provision unit will be described. In the embodiment, a server device (hereinafter, referred to as server device 1) as the maintenance service provision unit is described as an example. FIG. 3 is a block diagram illustrating the configuration of the maintenance service provision unit (server device).

The server device 1 is installed by a service provider providing the maintenance service of the printer to a user which installs and operates the printer 3 in order to monitor the printer 3 remotely. The server device 1 includes a CPU 11, a data accumulation unit 12, and an interface unit 13. The CPU 11 controls individual parts of the device so as to execute predetermined pieces of processing. The data accumulation unit 12 accumulates data of various types so as to form a database. The interface unit 13 performs information exchange with external devices.

The CPU 11 includes a controller 111 and an analyzing unit 112. The controller 111 executes previously set control programs so as to cause the individual parts to perform predetermined operations. The analyzing unit 112 performs appropriate analyzing processing based on given data. The data accumulation unit 12 includes an operation information accumulation unit 121, a failure information accumulation unit 122, and a service information accumulation unit 123.

The interface unit 13 includes an operating unit 131 and a display unit 132 as the configurations serving as a user interface. The operating unit 131 receives operation input from the user (operator). The display unit 132 displays pieces of information of various types and notifies the user of them. The operating unit 131 has an input device such as a keyboard and a mouse, for example. The display unit 132 has a display device such as a liquid crystal display, for example. The interface unit 13 includes a communication unit 133 that makes communication with other devices for data exchange. The communication unit 133 has a network connection function for connecting the server device 1 to the communication circuit 2.

The server device 1 receives the specification information transmitted from the printer 3 through the communication circuit 2, and the CPU 11 generates authentication information based on the received specification information and transmits the generated authentication information to the printer 3 through the communication circuit 2. The authentication information is generated by the specification information and information included in the server device 1. The authentication information contains information such as a receiving number, for example.

In the information processing system 100 configured as described above, when the printer 3 transmits the specification information containing information such as the serial number to the server device 1, the server device 1 generates the authentication information based on the specification information. The generated authentication information is transmitted to the printer 3 from the server device 1 and the printer 3 receives the authentication information.

In the information processing system 100, the printer 3 as a target receives only information that is transmitted from the server device 1 in the communication between the printer 3 and the server device 1. Therefore, communication between the printer 3 as the target and anything other than the server device 1 can be shut out. For example, information that is transferred between the printer 3 as the target and the server device 1 is encrypted and communication with other devices is shut out. With this, one-to-one correspondence between the printer 3 as the target and the server device 1 is formed so as to prevent entrance, interception, and the like by other people. The printer 3 is configured to receive information of the maintenance service and the like from the server device 1 after communication with anything other than the server device 1 is shut out. This simplifies procedures by the user to the maintenance service provider (server device 1) side, thereby improving the security level. Note that even when the printer 3 as the target shuts out communication with anything other than the server device 1, the server device 1 can make communication with other printers.

Further, in the information processing system 100, pieces of operation information of various types, which change with the operation of the printer 3, are transmitted to the server device 1 from the printer 3 through the communication circuit 2. The server device 1 saves the pieces of operation information of each printer 3 in the operation information accumulation unit 121 individually. With this, the operation conditions and history of each printer 3 are accumulated in the server device 1. Thus, the pieces of operation information acquired from each printer 3 and accumulated in the server device 1 are used for remote monitoring of the printer 3.

Further, the analyzing unit 112 analyzes the pieces of operation information that have been acquired from the plurality of printers 3 and accumulated so as to predict failures of the printers 3 and analyze reasons thereof. An analyzed result can be also used as information for developing a new product. To be specific, when failure has occurred on the printer 3, information related to a failure condition, which comes through the communication circuit 2 or from the service provider or the like that performs maintenance work at an installation place of the printer 3, is accumulated and saved in the failure information accumulation unit 122 as failure information. The analyzing unit 112 analyzes correlation between the pieces of operation information accumulated in the operation information accumulation unit 121 and the pieces of failure information accumulated in the failure information accumulation unit 122 so as to obtain causal relationship between the pieces of operation information and the failure.

With this, for example, when failure has occurred on the printer 3, the service provider is easy to find a type, a reason, a solving method, and the like of the failure based on the pieces of operation information of the corresponding printer 3. Moreover, the service provider predicts occurrence of failure based on the history of the pieces of operation information of the printer 3 connected to the communication circuit 2 and takes some measure at that time, thereby avoiding occurrence of failure. In this manner, the server device 1 can remotely monitor the respective printers 3 based on the accumulated pieces of operation information.

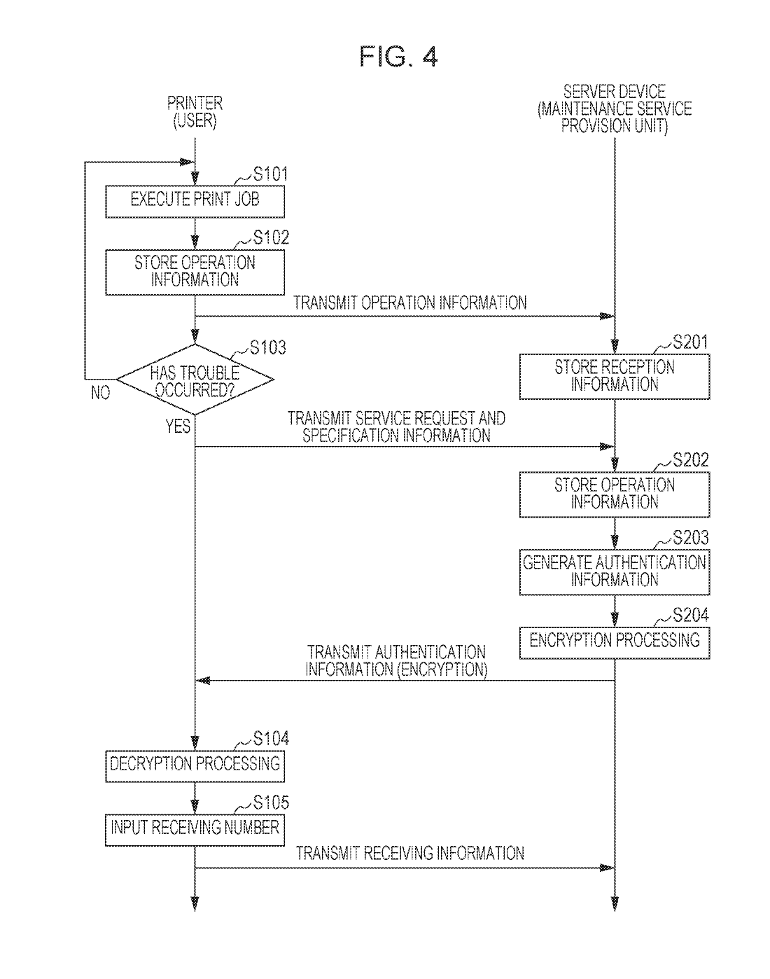

Next, an information processing method in the information processing system will be described. FIG. 4 is a flowchart illustrating the information processing method in the information processing system. In the embodiment, an authentication method (communication establishment method) between the server device 1 and the printer 3 as the target is described. That is to say, an authentication method between the maintenance service providing side (server device 1) and the user side (printer 3) receiving provision of the maintenance service is described. The information processing method in the embodiment is a method in which specification information specifying the information processing device (printer 3) is transmitted to the maintenance service provision unit (server device 1) providing the maintenance service. With the information processing method, encryption processing is performed and communication between the printer 3 as the target and anything other than the server device 1 is shut out in the communication between the printers 3 and the server device 1. After communication between the printer 3 as the target and anything other than the server device 1 is shut out, the printer 3 receives information of the maintenance service from the server device 1. Details thereof will be described below.

First, the printer 3 executes a print job (step S101). To be specific, the CPU 31 drives the print engine 341 of the print unit 34 based on the control program. With this, the print engine 341 is driven and an image is formed on the recording medium.

Then, the operation information is stored (step S102). To be specific, pieces of information that change with the execution of the print job, for example, pieces of information of the number of print sheets and an ink usage amount, are stored and saved in the storage unit 32 of the printer 3 as the pieces of operation information. The storage of the pieces of operation information is made by the storage unit 32 of the printer 3 and the stored pieces of operation information are transmitted to the server device 1 regularly and irregularly.

When the server device 1 receives the pieces of operation information from the printer 3, it stores and accumulates the pieces of operation information in the operation information accumulation unit 121 individually for each printer 3 (step S201).

Thereafter, it is determined whether or not a trouble has occurred on the printer 3 (step S103). When no trouble has occurred (NO at step S103), the process proceeds to step S101. On the other hand, when some trouble has occurred on the printer 3 (YES at step S103), a message indicating an error state is displayed on the display unit 332 and the user is notified of it. Further, a service request screen is displayed on the display unit 332. The service request screen is a screen on which the user shows his(her) intension of online request for the maintenance service by the maintenance service provider with whom the user has a maintenance service contract (through the communication circuit 2). It should be noted that the service request screen is preferably displayed in occurrence of some error only.

Then, the service request is transmitted from the user side to the maintenance service provider side. In this case, the specification information containing the individual information such as the serial number of the printer 3 is transmitted. The individual information is data that is automatically transmitted as accompanying data previously when the service request is made to the maintenance service provider side. Accordingly, the individual information is transmitted to the maintenance service provider side without requiring the user to input the serial number attached to the printer 3 with the operating unit 331 or the like. This reduces user's burden and prevents the target printer 3 from being mistaken. Further, when the user makes the service request to the maintenance service provider, a special key operation is performed. That is to say, an operation different from a normally used key operation is performed. For example, the service request is made by pressing arbitrary three buttons among the four buttons (keys) 331a to 331d as illustrated in FIG. 2B at the same time. This can reduce transmission mistake by the user. As other transmittable information, the pieces of output data from the sensors 342 and the counters 343, the setting information of the printer 3, and information related to the print job may be transmitted appropriately.

Subsequently, when the server device 1 receives the specification information of the printer 3, the specification information is stored in the operation information accumulation unit 121 (step S202). Then, the server device 1 generates authentication information (in the embodiment, receiving number information) based on the received specification information (step S203). The generated authentication information is encrypted and is transmitted to the printer 3 (step S204).

Then, the printer 3 decrypts the encrypted authentication information (step S104). This enables only the printer 3 (user) as the target to read the authentication information. The user inputs receiving number information decrypted using the operation unit 331 and the like of the printer 3 and transmits the input receiving number information to the server device 1 (step S105). With this, the server device 1 specifies (recognizes) the printer 3 as the target.

As described above, the following effects can be obtained with the above-mentioned embodiment.

For example, when a trouble has occurred on the printer 3 and service provision from the maintenance service provision unit 1 (server device 1) is requested, the specification information containing the individual information (serial number) of the printer 3 is automatically transmitted to the server device 1 from the printer 3. Therefore, user's burden is reduced and the printer 3 which is to receive provision of the maintenance service can be specified easily. Further, information that is transmitted and received between the printer 3 and the server device 1 is encrypted, thereby improving the level of information security.

The invention is not limited to the above-mentioned embodiment and various changes and improvements can be added to the above-mentioned embodiment. Modifications will be described below.

### Modification 1

Although the server device 1 and the printers 3 are connected through the communication circuit 2 in the above-mentioned embodiment, the invention is not limited thereto. For example, the information processing system may be configured by a computer and the printers 3 that are controlled by the computer. In this information processing system, the server device 1 and the computer may transmit and receive information therebetween through the communication circuit 2. Alternatively, the information processing system may have a configuration in which a computer and the printers 3 that are controlled by the computer are connected through a local area network (LAN). With this configuration, the same effects as those as described above can be obtained.

### Modification 2

Although the maintenance service provider uses an electronic unit in order to contact the user in the above-mentioned embodiment, the invention is not limited thereto. For example, as a mode in which the maintenance service provider contacts the user, the maintenance service provider may call a previously specified contact destination using a telephone or a facsimile, for example. Also in this manner, the maintenance service provider can acquire the specification information of the printer 3 so as to specify the user (printer 3).

### Modification 3

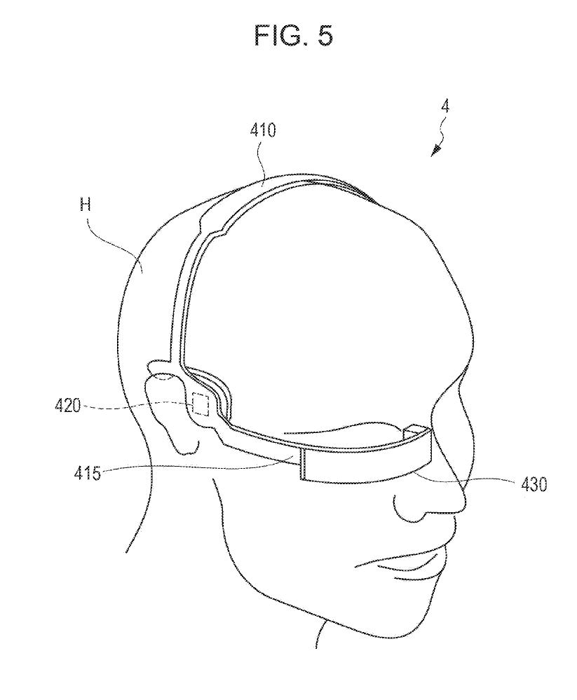

Although the maintenance service provider uses the electronic unit in order to contact the user in the above-mentioned embodiment, transmission and reception of information to and from the maintenance service provider may be performed using a head mount display (HMD), for example. FIG. 5 is a configuration diagram illustrating the configuration of an information processing device according to a modification. To be specific, FIG. 5 illustrates the configuration of the head mount display (HMD) as the information processing device. As illustrated in FIG. 5, a head mount display 4 includes a mounting portion 410 that is mounted on a head portion H of the user (operator) and an extension portion 415 that extends from the mounting portion 410. A communication unit 420 and the like are provided on the mounting portion 410. A display unit 430 is provided on the extension portion 415. The communication unit 420 and the printer 3 can transmit and receive pieces of information of various types wirelessly. The communication unit 420 acquires the specification information from the printer 3 and can transmit the specification information of the printer 3 to the server device 1 from the head mount display 4. With this, the printer 3 can be recognized.

### Modification 4

Although the pieces of operation information of the printer 3 are transmitted to the server device 1 before a trouble occurs on the printer 3 in the above-mentioned embodiment, the invention is not limited thereto. For example, the pieces of operation information and the like may be transmitted when a trouble has occurred on the printer 3. With this configuration, the same effects as those as described above can be obtained.

The entire disclosure of Japanese Patent Application No. 2014-155932, filed Jul. 31, 2014 is expressly incorporated by reference herein.

What is claimed is:

1. An information processing device comprising a communication unit that makes communication with a maintenance service provision unit providing maintenance service,
wherein the communication unit transmits specification information specifying the information processing device to the maintenance service provision unit.

2. The information processing device according to claim 1,
wherein the specification information contains at least individual information specifying the information processing device or positional information specifying a position of the information processing device.

3. The information processing device according to claim 1, further including a recognizing unit which recognizes start of the maintenance service,
wherein when the recognizing unit has recognized a predetermined condition for starting the maintenance service, the specification information is transmitted to the maintenance service provision unit.

4. The information processing device according to claim 1,
wherein the communication unit receives authentication information generated by the maintenance service provision unit based on the specification information through a communication circuit.

5. The information processing device according to claim 4,
wherein the authentication information is generated by the specification information and information included in the maintenance service provision unit.

6. The information processing device according to claim 4, further including a display unit that displays the authentication information received.

7. The information processing device according to claim 4,
wherein communication is encrypted based on the authentication information.

8. The information processing device according to claim 1,
wherein communication with anything other than the maintenance service provision unit is capable of being shut out.

9. The information processing device according to claim 1,
wherein after communication with anything other than the maintenance service provision unit is shut out, information of the maintenance service is received from the maintenance service provision unit.

10. An information processing system that transmits specification information specifying an information processing device to a maintenance service provision unit providing maintenance service.
